(19) United States
(12) Patent Application Publication
(10) Pub. No.: US 2010/0142374 A1
(43) Pub. Date: Jun. 10, 2010

(54) FLOW QoS ETHERNET SWITCH AND FLOW QoS PROCESSING METHOD USING THE SAME

(75) Inventors: Seung Hyun YOON, Daejeon (KR); You Hyeon JEONG, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/570,444

(22) Filed: Sep. 30, 2009

(30) Foreign Application Priority Data
Dec. 8, 2008 (KR) 10-2008-0124007
Apr. 8, 2009 (KR) 10-2009-0030244

(51) Int. Cl. H04L 12/26; H04L 12/56

(52) U.S. Cl. 370/235; 370/420

(57) ABSTRACT

There are provided a QoS Ethernet switch and a flow QoS processing method using the same. More particularly, there is provided a technology that can easily ensure IP service quality at low cost by introducing IP flow QoS function to an Ethernet switch.

### CROSS-REFERENCE TO RELATED APPLICATIONS

This application claims the priorities of Korean Patent Application Nos. 10-2008-0124007 filed on Dec. 8, 2008, and 10-2009-0030244 filed on Apr. 8, 2009, in the Korean Intellectual Property Office, the disclosures of which are incorporated herein by reference.

### BACKGROUND OF THE INVENTION

1. Field of the Invention

The present invention relates to a QoS Ethernet switch and a flow QoS processing method using the same, and more particularly, to a QoS Ethernet switch and a flow QoS processing method using the same that can easily ensure IP service quality at low cost by introducing IP flow QoS function to an Ethernet switch.

2. Description of the Related Art

Currently, most network services have evolved into IP-based services. Also, much of the traffic passing through Ethernet switches is IP traffic, such trend is predicted to only increase in the future.

In general, the network performance of IP networks depends on the performance of lower-layer networks used to establish connections between routers. Currently, the most deployed technology to establish connections between routers in IP networks is Ethernet technology. Equipment that provides QoS per IP flow is required to ensure the quality of IP services. Current Ethernet switches do not support QoS and only transmit traffic by operating IEEE 802.1p-based priority queues, irrelevant to IP flows, while being unable to provide IP flow recognition and QoS support.

In order to ensure QoS in IP networks, IP routers (S-series, Sable Networks) have been released and are being partially used in the networks. These flow QoS routers manage traffic per IP flow and provide QoS support such as a bandwidth guarantee per IP flow.

However, routers are generally more expensive than Ethernet switches. It is also difficult to change existing routers to flow QoS routers due to complex IP network operation management. Furthermore, in terms of costs, it is very difficult to change all existing routers to flow QoS routers.

### SUMMARY OF THE INVENTION

An aspect of the present invention provides a flow QoS Ethernet switch and a flow QoS processing method using the same that can easily ensure IP service quality at low cost by introducing IP flow QoS function to an Ethernet switch.

According to an aspect of the present invention, there is provided a flow QoS Ethernet switch including: a packet switch performing Ethernet layer switching; and a plurality of flow QoS line cards located at an input terminal or an output terminal of the packet switch and providing QoS for IP flows passing through the packet switch.

Each of the flow QoS line cards may include: a classifier transmitting packets to an IP flow QoS engine or a transmitter according to whether the packets input through an external interface or the packet switch are IP packets subject to flow QoS; an IP flow QoS engine receiving the IP packets subject to flow QoS from the classifier and applying per-flow QoS to the IP packets; and a transmitter transmitting the packets transmitted from the classifier or the IP flow QoS engine to the packet switch or the outside.

Each of the flow QoS line cards may further include a flow QoS traffic information DB storing information about traffic subject to flow QoS, and the classifier may classify the traffic subject to flow QoS with reference to the flow QoS traffic information DB.

Each of the flow QoS line cards may further include a flow QoS profile information DB storing a flow QoS profile, and the IP flow QoS engine may apply per-flow QoS to the IP packets subject to flow QoS with reference to the flow QoS profile information DB.

According to another aspect of the present invention, there is provided a flow QoS processing method using an Ethernet switch supporting IP flow QoS, the method including: determining whether packets input through an external interface or a packet switch correspond to traffic subject to flow QoS; determining whether the input packets are IP packets when the input packets correspond to traffic subject to flow QoS; accessing flow QoS profile information about the IP packets subject to flow QoS; and applying flow QoS to the IP packets subject to flow QoS according to the flow QoS profile information.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration view illustrating a network to which flow QoS Ethernet switches are applied according to an exemplary embodiment of the present invention;

FIG. 2 is a configuration view illustrating a flow QoS Ethernet switch according to an exemplary embodiment of the present invention;

FIG. 3 is a detailed configuration view illustrating the flow QoS line card, shown in FIG. 2; and

FIG. 4 is a flow chart illustrating a flow QoS process of the flow QoS line card, shown in FIG. 3.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

It will be understood that when an element is referred to as being “connected with” another element, it can be directly connected with the other element or intervening elements may also be present. In contrast, when an element is referred to as being “directly connected with” another element, there are no intervening elements present. In addition, unless explicitly described to the contrary, the word “comprise” and variations such as “comprises” or “comprising,” will be understood to imply the inclusion of stated elements but not the exclusion of any other elements.

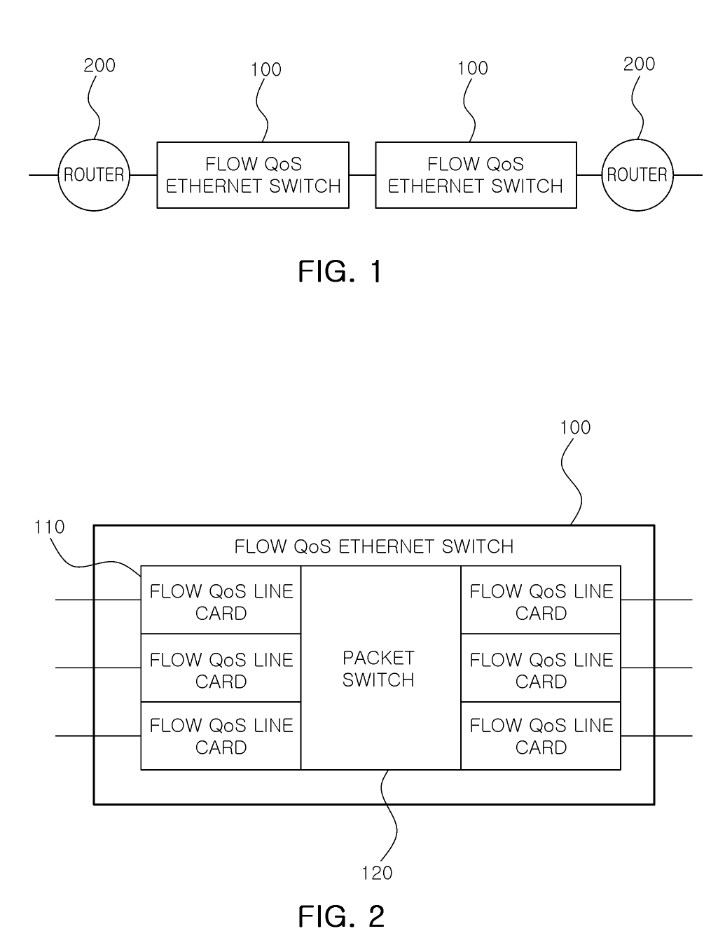

FIG. 1 is a configuration view illustrating a network to which flow QoS Ethernet switches are applied according to an exemplary embodiment of the invention.

According to this embodiment, flow QoS Ethernet switches 100, providing QoS for IP flows in order to ensure IP service quality, perform L2 (Ethernet) layer switching and at the same time, and provide end-to-end IP flow QoS by adjusting packet transmission priority with respect to IP packets through per-flow management and queuing mechanisms.

As shown in FIG. 1, the flow QoS Ethernet switches 100 according to this embodiment are connected between routers 200 according to the related art that only support best-effort service and provide end-to-end IP flow QoS. Though not shown in FIG. 1, pieces of equipment, such as Ethernet switches and multiService provisioning platform (MSPPs) according to the related art, may be located between the QoS Ethernet switches 100.

As such, when the network is configured using the flow QoS Ethernet switches 100 and the routers 200 according to the related art, the routers 200 perform IP packet routing, and the flow QoS Ethernet switches 100 switch Ethernet layers and provide IP flow QoS.

FIG. 2 is a configuration view illustrating a flow QoS Ethernet switch according to an exemplary embodiment of the invention.

As shown in FIG. 2, a flow QoS Ethernet switch 100 according to this embodiment includes a plurality of flow QoS line cards 110 and a packet switch 120.

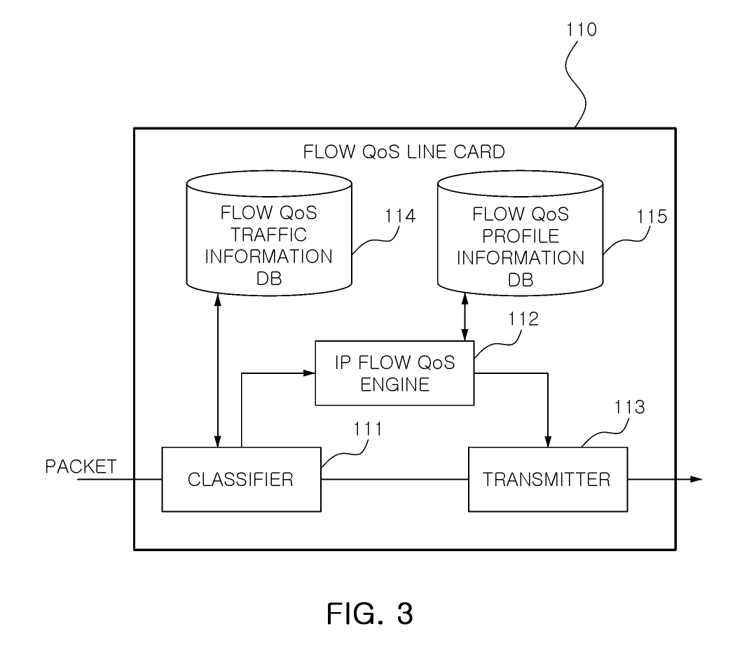

The flow QoS line cards 110 are included to provide QoS for IP flows. The configuration and function thereof will be described below in detail with reference to FIG. 3.

The packet switch 120 performs general Ethernet layer switching, which can be implemented by the technology known in the related art. Thus, a detailed description of the packet switch 120 will be omitted.

FIG. 3 is a detailed configuration view illustrating the flow QoS line card, shown in FIG. 2.

In FIG. 3, except for the configuration for Ethernet switching that is provided for a general Ethernet switch, a configuration for providing QoS for IP flows will be only described in detail according to an exemplary embodiment of the invention.

The flow QoS line card 110 includes a classifier 111, an IP flow QoS engine 112, a transmitter 113, a flow QoS traffic information DB 114 and a flow QoS profile information DB 115.

The classifier 111 determines whether packets being input correspond to traffic subject to flow QoS and whether or not the input packets are IP packets. The classifier 111 transmits the input packets to the IP flow QoS engine 112 when the input packets are IP packets subject to flow QoS or otherwise transmits the input packets to the transmitter 113.

Here, the classifier 111 may classify the traffic subject to flow QoS with reference to information on traffic subject to flow QoS that is stored in the flow QoS traffic information DB 114. Here, identifiers, used for traffic classification, may be defined as source and destination MAC addresses when the flow QoS Ethernet switch 100 including the flow QoS line cards 110 is merely an L2 Ethernet switch. Alternatively, the identifiers may be defined as a C-tag, an S-tag, route information of PBT/MPLS-TP and a combination thereof in a metro Ethernet, which is the Internet via Ethernet in a LAN environment.

The IP flow QoS engine 112 receives the IP packets subject to flow QoS from the classifier 111 and processes the packets per flow. Specifically, the IP flow QoS engine 112 applies per-flow QoS with reference to flow QoS profiles stored in the flow QoS profile information DB 115.

The IP flow QoS engine 112 may be implemented by borrowing the configuration and function used in the flow QoS router according to the related art. The flow QoS router only performs per-flow packet processing of the IP packets according to the related art, while the IP flow QoS engine 112 can manage the entire Ethernet frame including the IP packets in units of IP flows according to this embodiment.

The transmitter 113 outputs the traffic transmitted from the classifier 111 or the IP flow QoS engine 112 to the packet switch 120 or to the outside.

The above-described packet flow may be equally applied to the flow QoS line cards 110 at both, or any one of the input and output terminals of the flow QoS Ethernet switch 100.

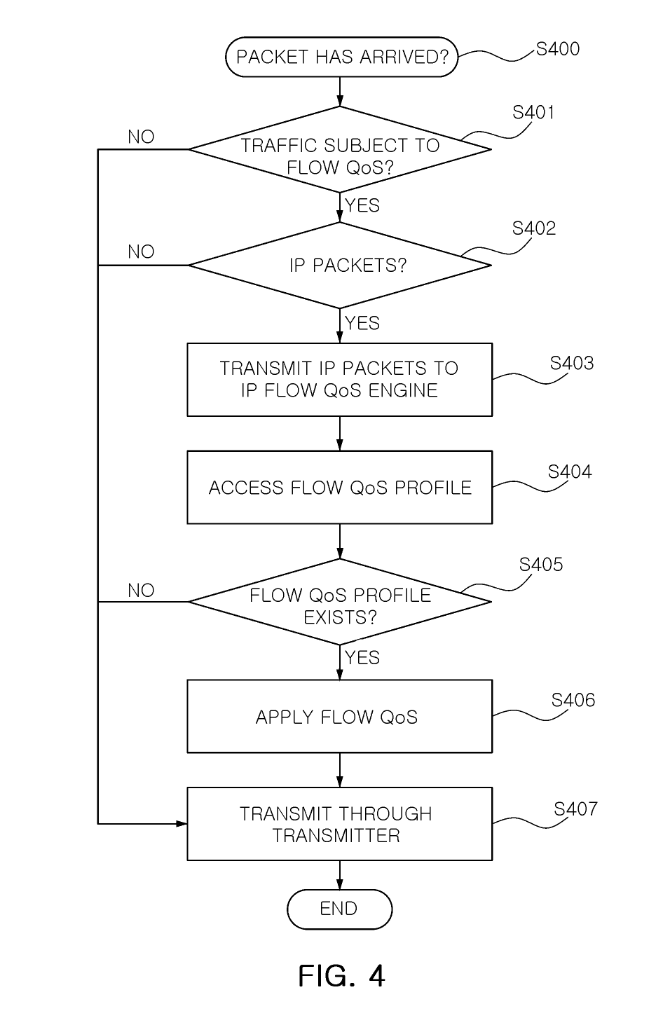

FIG. 4 is a flow chart illustrating a flow QoS process in the flow QoS line card, shown in FIG. 3.

First, when packets arrive at the flow QoS line card 110 through an external interface or the packet switch 120 in operation S400, the classifier 111 determines whether the input packets correspond to traffic subject to flow QoS according to information set beforehand, that is, information stored in the flow QoS traffic DB 114 in operation S401.

As a result of the determination, when the packets are not traffic flow subject to QoS, the classifier 111 transmits the packets directly to the transmitter 113 without passing them through the IP flow QoS engine 112 so that the packets are then transmitted through the packet switch or the external interface in operation S407.

On the other hand, when the packets correspond to traffic subject to flow QoS, the classifier 111 determines whether the packets are IP packets in operation S402 and transmits the packets to the IP flow QoS engine 112 when the packets are IP packets in operation S403 or otherwise transmits the packets to the transmitter 113.

Then, the IP flow QoS engine 112 having received the IP packets, which are subject to flow QoS, accesses flow QoS profile information set beforehand in operation S404. When there is a flow QoS profile with respect to the transmitted packets in operation S405, the IP flow QoS engine 112 applies flow QoS to the packets according to the flow QoS profile in operation S406.

The IP packets having been applied with flow QoS are transmitted to the packet switch or the external interface through the transmitter 113 in operation S407.

As set forth above, according to exemplary embodiments of the invention, IP service quality can be increased by changing general Ethernet switches to flow QoS Ethernet switches supporting IP flow QoS in an IP network according to the related art.

Furthermore, costs can be reduced and applicability can be increased by changing general Ethernet switches to flow QoS Ethernet switches as compared with the case in which general routers are changed to flow QoS routers.

While the present invention has been shown and described in connection with the exemplary embodiments, it will be apparent to those skilled in the art that modifications and variations can be made without departing from the spirit and scope of the invention as defined by the appended claims.

What is claimed is:

1. A flow QoS Ethernet switch comprising:
a packet switch performing Ethernet layer switching; and
a plurality of flow QoS line cards located at an input terminal or an output terminal of the packet switch and providing QoS for IP flows passing through the packet switch.

2. The flow QoS Ethernet switch of claim 1, wherein each of the flow QoS line cards comprises:
a classifier transmitting packets to an IP flow QoS engine or a transmitter according to whether the packets input through an external interface or the packet switch are IP packets subject to flow QoS;
an IP flow QoS engine receiving the IP packets subject to flow QoS from the classifier and applying per-flow QoS to the IP packets; and
a transmitter transmitting the packets transmitted from the classifier or the IP flow QoS engine to the packet switch or the outside.

3. The flow QoS Ethernet switch of claim 2, wherein each of the flow QoS line cards further comprises a flow QoS traffic information DB storing information about traffic subject to flow QoS, and
the classifier classifies the traffic subject to flow QoS with reference to the flow QoS traffic information DB.

4. The flow QoS Ethernet switch of claim 2, wherein each of the flow QoS line cards further comprises a flow QoS profile information DB storing a flow QoS profile, and
the IP flow QoS engine applies per-flow QoS to the IP packets subject to flow QoS with reference to the flow QoS profile information DB.

5. A flow QoS processing method using an Ethernet switch supporting IP flow QoS, the method comprising:
determining whether packets input through an external interface or a packet switch correspond to traffic subject to flow QoS;
determining whether the input packets are IP packets when the input packets correspond to traffic subject to flow QoS;
accessing flow QoS profile information about the IP packets subject to flow QoS; and
applying flow QoS to the IP packets subject to flow QoS according to the flow QoS profile information.
